(19) United States
(12) Patent Application Publication
(10) Pub. No.: US 2012/0318460 A1
(43) Pub. Date: Dec. 20, 2012

(54) Drum

(76) Inventors: Sebastian Popp, Fulda (DE); Dieter Grosch, Huenfeld (DE)

(21) Appl. No.: 13/494,738

(22) Filed: Jun. 12, 2012

(30) Foreign Application Priority Data
Jun. 15, 2011 (DE) 10 2011 077 569.2

(51) Int. Cl. B29D 30/24

(52) U.S. Cl. 156/415

(57) ABSTRACT

A drum for the manufacture of a tire, in particular for winding or clamping a tire body, includes a circular cylindrical drum unit formed from circular-arc-shaped drum segments. The drum segments are movable in a radial direction, transversely to a rotation axis of the drum, such that an external diameter of the drum unit is changeable. The drum further includes an actuation device and a deflection device. The actuation device moves the drum segments. The deflection device has obliquely arranged telescopic guides that transfer an axial movement of the actuation device into a radial movement of the drum segments.

### CROSS REFERENCE TO RELATED APPLICATION

The present application claims the benefit of German Patent Application No. 10 2011 077 569.2 filed Jun. 15, 2011, which is fully incorporated herein by reference.

### STATEMENT REGARDING FEDERALLY SPONSORED RESEARCH OR DEVELOPMENT

Not applicable.

### FIELD OF THE INVENTION

The invention relates to a drum for the manufacture of a tire, in particular for the winding or clamping of a tire body, wherein the drum comprises a circular cylindrical drum unit which is formed from circular-arc-shaped drum segments, wherein the drum segments are movable in a radial direction, transversely to a rotation axis of the drum, such that an external diameter of the drum unit is changeable, wherein the drum comprises an actuation device, by means of which the drum segments are movable, and wherein the drum comprises a deflection device.

### BACKGROUND OF THE INVENTION

Such drums are sufficiently known from the prior art and serve substantially for the manufacture or respectively for the winding of a tire body. The drum is constructed here in the manner of a clamping mandrel from a plurality of drum segments, which are distributed over a periphery of the drum unit and thus form the drum unit. Provision is made here, by means of the movable drum segments, to expand the external diameter of the drum unit and to wind or respectively complete a body on a surface of the drum unit by rotation of the drum or respectively of the drum unit. In order to be able to remove the finished tire body from the drum unit, it is necessary to contract the external diameter of the drum unit by a movement of the drum segments transversely to a rotation axis of the drum. Owing to a play which is thus brought about between the tire body and the drum unit, it becomes possible to remove the tire body from the drum or respectively from the drum unit in an axial direction. Provision is therefore made to mount the drum rotatably only at one end, because the opposite end must remain free for the removal of the tire body or respectively must have no continuous shaft.

A disadvantage in the known drums is that they only permit a small, radial alteration of the external diameter of the drum unit. Thereby, a removal or respectively stripping of a finished tire body from the drum unit is made difficult, because the tire body can only be moved within the play which is produced by the contraction of the external diameter. In addition, an axial length of the drum unit is limited, so that only tire body with small widths can be manufactured.

### SUMMARY OF THE INVENTION

The present invention is therefore based on the problem of proposing a drum for the manufacture of a tire body, which enables a simplified handling of a tire body. This problem is solved by a drum having a circular cylindrical drum unit formed from circular-arc-shaped drum segments. The drum segments are movable in a radial direction, transversely to a rotation axis of the drum, such that an external diameter of the drum unit is changeable. The drum further includes an actuation device and a deflection device. The actuation device moves the drum segments The deflection device has obliquely arranged telescopic guides that transfer an axial movement of the actuation device into a radial movement of the drum segments.

The drum according to the invention for the manufacture of a tire, in particular for winding or clamping a tire body, comprises a circular cylindrical drum unit, which is formed from circular-arc-shaped drum segments, wherein the drum segments are movable in a radial direction, transversely to a rotation axis of the drum, such that an external diameter of the drum unit is changeable, wherein the drum comprises an actuation device, by means of which drum segments are movable, wherein the drum comprises a deflection device which has obliquely arranged guide arrangements, wherein by means of the guide arrangements an axial movement of the actuation device is able to be transferred into a radial movement of the drum segments, wherein the guide arrangements are constructed as telescopic guides.

Telescopic guides in the sense of the invention are to be understood here to mean extendable guide arrangements, which are suitable for increasing or reducing the guide arrangements themselves in their length. Through the fact that telescopic guides are used for the movement of the drum segments, it becomes possible to move the drum segments within a comparatively large movement range, whereby a particularly small, contracted external diameter of the drum unit can be formed, if required. A finished wound tire body is then able to be handled in a particularly simple manner, because a comparatively large play exists between the tire body and the contracted external diameter. Provision is further made to arrange the telescopic guides obliquely for the movement of the drum segments. An axial movement of the actuation device in the direction of the rotation axis of the drum can then be simply deflected into a movement of the telescopic guides or respectively into a movement of the drum segments. As guide arrangements which are arranged and constructed in such a way can require relatively little structural space, a particularly small, contracted external diameter can be formed.

Advantageously, the drum can comprise a holding device, wherein by means of the holding device the drum segments are held in axial direction. Thus, by means of the holding device it can be effectively avoided that the drum segments move at all in axial direction. An axial movement of the actuation device can then be transferred completely into a radial movement of the drum segments. The deflection device can then, in the manner of a gear unit, transfer the movement of the actuation device into the movement of the drum segments. A transmission can be selected here as a function of an angle α of the obliquely arranged guide arrangements relative to the rotation axis of the drum, because from an inclination of the guide arrangements on a movement thereof, an axial and a radial movement component is produced as a function of the inclination or respectively of the angle α. A holding device can be constructed here for example in the manner of an axial stop.

The holding device is able to be constructed particularly simply if it comprises radially arranged guide arrangements, which respectively guide the drum segments in radial direction. Then it becomes possible in particular to hold the drum segments axially also on a movement thereof in radial direction. A radial guidance can then also prevent any axial movement of the drum segments. Also, a guide arrangement can be constructed for each drum segment, in order to be able to take into account movements of the drum segments which may deviate from one another.

The guide arrangements of the holding device can also be constructed as a telescopic guide. Thereby, the guide arrangements can also be arranged inside the drum unit, whereby a configuration of the guide arrangements is basically no longer limited to a closed end of the drum unit. Also, the use of the telescopic guides enables here a construction of a particularly small, contracted external diameter of the drum unit.

The telescopic guides can be formed respectively from at least two linear guides. Linear guides are comparatively simple to produce and are therefore available at a favourable cost. Also, linear guides, according to degree of overlap of guide elements, enable a transfer of comparatively high transverse forces. A linear guide can be constructed as a linear sliding guide of two guide elements or as a linear rolling guide with rolling bodies between two guide elements. As at least two linear guides are provided for the construction of the telescopic guides, the telescopic guide can also be constructed for example from three guide elements, which form two linear guides. The linear guide can be formed in the manner of a dovetail guide, rail guide or round bar guide. A telescoping capability of the linear guides or respectively of the guide elements can be achieved by a parallel offset arrangement of the guide elements relative to one another or a coaxial arrangement of the guide elements.

It is particularly advantageous if the deflection device is connected in a torque-proof manner with a drive shaft of the drum. The drive shaft of the drum, i.e. the shaft which is used for the bearing and rotation of the drum unit, can then transfer a torque directly via the deflection device to the drum unit or respectively to the drum segments. The drum segments can thus be simply fastened in a torque-proof manner on the drive shaft.

In order to obtain a comparatively wide drum unit having a great axial length, the drum can comprise a further second deflection device, which is spaced apart from the first deflection device. The axial movement of the actuation device can then be transferred via both deflection devices to the drum unit or respectively to the respective drum segments. Thus, it can be avoided that a jamming of the drum segments occurs due to one-sided loading of the drum unit, because an actuation force can be distributed by means of the two deflection devices relatively uniformly onto a length of the drum unit. Basically, it thus also becomes possible to construct comparatively wide tire bodies or to manufacture a plurality of tire bodies simultaneously with the drum. Depending on the case of application and the length of the drum unit, further deflection devices can also be provided.

The drum unit can comprise a set of outer drum segments and a set of inner drum segments, which in turn can be arranged respectively alternately over a periphery of the drum unit. A use of two types of drum segments makes it possible, with a contraction of the external diameter, to separate the respective drum segments from one another in a suitable manner.

Thus, an external diameter D of the drum unit can be formed in an expanded position of the drum unit by all drum segments, and an external diameter d of the drum unit can be formed in a contracted position of the drum unit by solely the outer drum segments. Thus, it becomes possible that in the expanded position of the drum unit, a substantially closed circular cylinder can be formed from all drum segments. Gaps between the drum segments on the periphery of the drum unit, such as are known from clamping mandrels, can thus be avoided. A tire body can then be constructed in a particularly precise manner. When, in the contracted position, the outer drum segments form the external diameter d, the inner drum segments can be arranged inside the drum unit or respectively inside the circular cylinder which is thus formed. Thereby, it likewise becomes possible to reduce external diameter d in size as far as possible.

In this respect, it is advantageous if the telescopic guides for the inner drum segments have a greater guide length than the telescopic guides for the outer drum segments. The inner drum segments can then be moved further in radial direction than the outer drum segments. Also, via respectively different inclinations of the guide arrangements of the inner and outer drum segments, different movement lengths can be brought about with a movement of equal size of the actuation device.

The deflection device can have a first conical ring and a second conical ring, wherein the first conical ring can hold telescopic guides for the outer drum segments and the second conical ring can hold telescopic guides for the inner drum segments. Accordingly, the respective telescopic guides for the drum segments can be fastened to the conical rings, wherein then a telescopic guide can be simply fastened at an angle α relative to the rotation axis of the drum on the conical ring. Thus, a cone of the conical ring can have in particular the angle a. In addition, a movement of the outer drum segments and of the inner drum segments can then also be brought about separately from one another by a respective movement of the conical rings.

For this, the conical rings can be arranged concentrically on a drive shaft of the drum and be axially movable. The conical rings can also be connected with the drive shaft, so that an axial guide of the drive shaft is formed for the conical rings.

In addition, the actuation device can have at least one fluid piston which is arranged concentrically on the drive shaft and is axially movable. Thereby, it becomes possible to move the conical rings in axial direction by means of the fluid piston. The fluid piston can be driven hydraulically or pneumatically. In addition, it is also conceivable to provide, instead of a fluid piston, an electromechanical linear drive or a drive which is not concentrically arranged on the drive shaft for the conical rings. A concentrically arranged fluid piston is, however, very compact and can generate great actuation forces.

The actuation device can also have a further fluid piston, wherein the further fluid piston can move one of the two conical rings. Thus, the first conical ring can be coupled with the first fluid piston and the second conical ring can be coupled with a second fluid piston. Consequently, the two conical rings can be moved respectively by different fluid pistons, whereby different radial movement lengths can be achieved for each conical ring and hence for the respective drum segments. The fluid pistons can be constructed separately from one another or also in the manner of a series connection with one another. In this case, one of the fluid pistons only has to balance out a difference of a movement length between the respectively differing drum segments.

In so far as the conical ring is spaced apart from the fluid piston, the conical ring can be coupled to the fluid piston by means of an extension arrangement of the actuation device. Thus, also with the use of a second deflection device, a conical ring thereof can be coupled to the associated fluid piston. The extension arrangement can be formed for example in the manner of a sleeve arranged concentrically on the drive shaft or also by rods which connect the conical ring with the fluid piston.

In a particularly simple embodiment, the conical ring can also be formed by the fluid piston. When the conical ring is to be arranged relatively tightly against the fluid piston, the fluid piston can be shaped such that it has a cone which is able to be used as a conical ring.

In order to be able to control a movement of the drum which is adapted to a manufacturing cycle and to control a movement, coordinated with one another, of the respective drum segments for the formation of the necessary external diameters of the drum unit in a suitable manner, the actuation device can comprise a control arrangement for controlling a movement of the fluid piston. The control arrangement can comprise, inter alia, a simultaneous controlling of several fluid pistons and of a rotary drive of the drum.

### BRIEF DESCRIPTION OF THE DRAWINGS

A preferred embodiment of the invention is explained in further detail below with reference to the enclosed drawings.

There are shown:

FIG. 1 a drum in an expanded position in a side view;

FIG. 2 the drum in a contracted position in a side view;

FIG. 3 the drum in a sectional view along a line III-III of FIG. 1;

FIG. 4 the drum in a sectional view along a line IV-IV of FIG. 2;

FIG. 5 the drum in a sectional view along a line V-V of FIG. 1;

FIG. 6 a perspective view of a front side of the drum; and

FIG. 7 a perspective view of a rear side of the drum.

### DETAILED DESCRIPTION OF THE EXAMPLE EMBODIMENTS

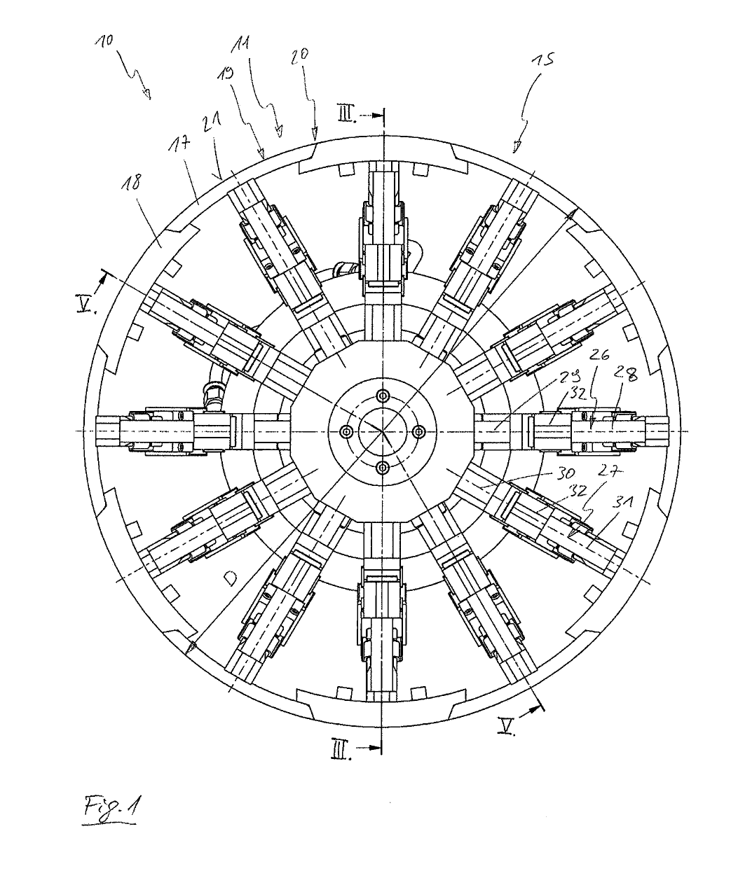

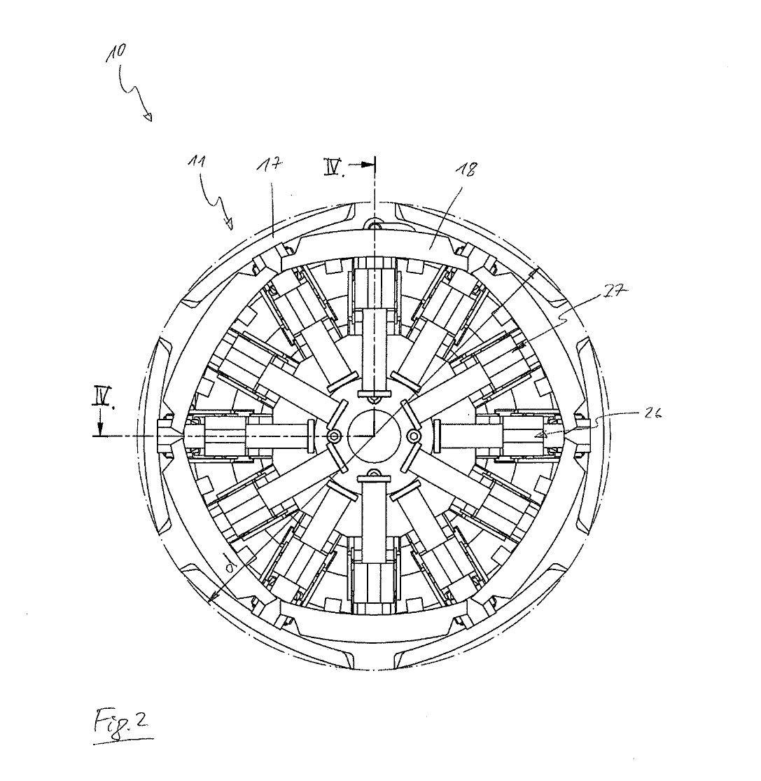

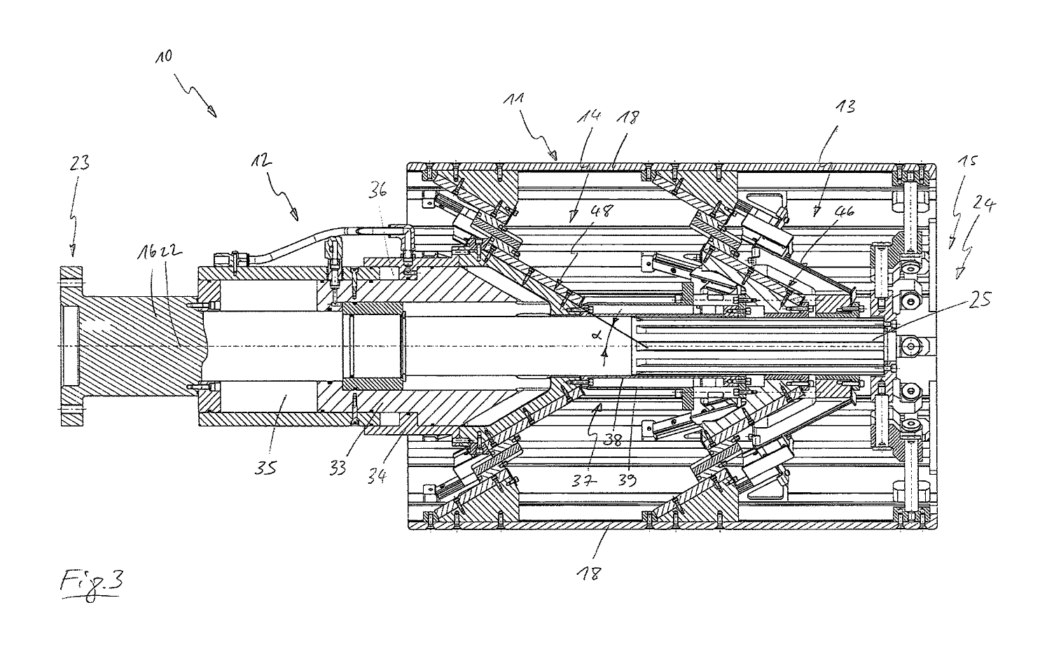

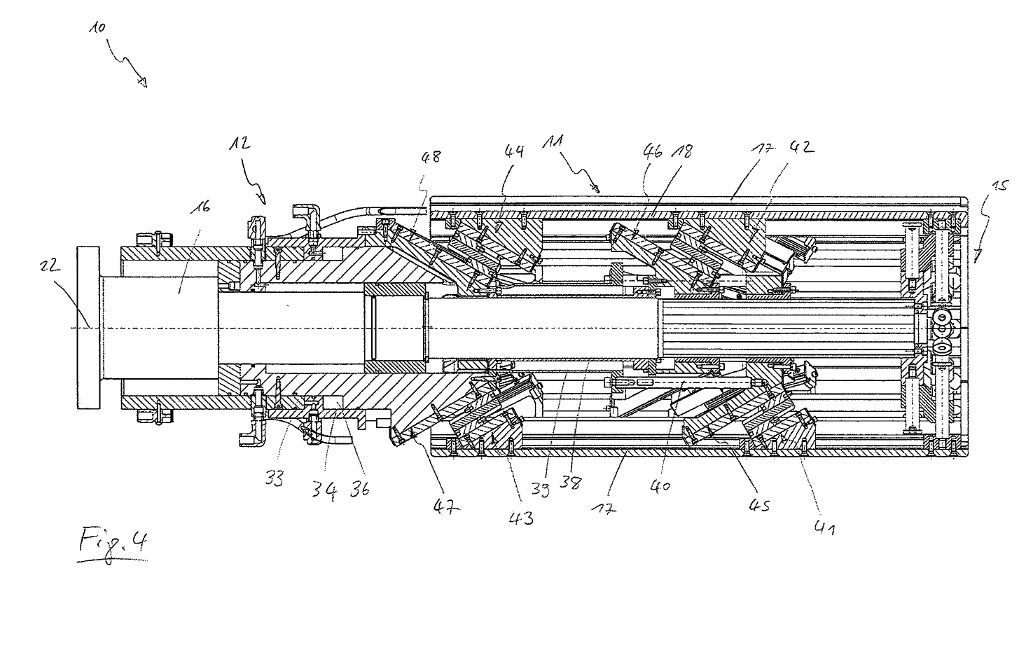

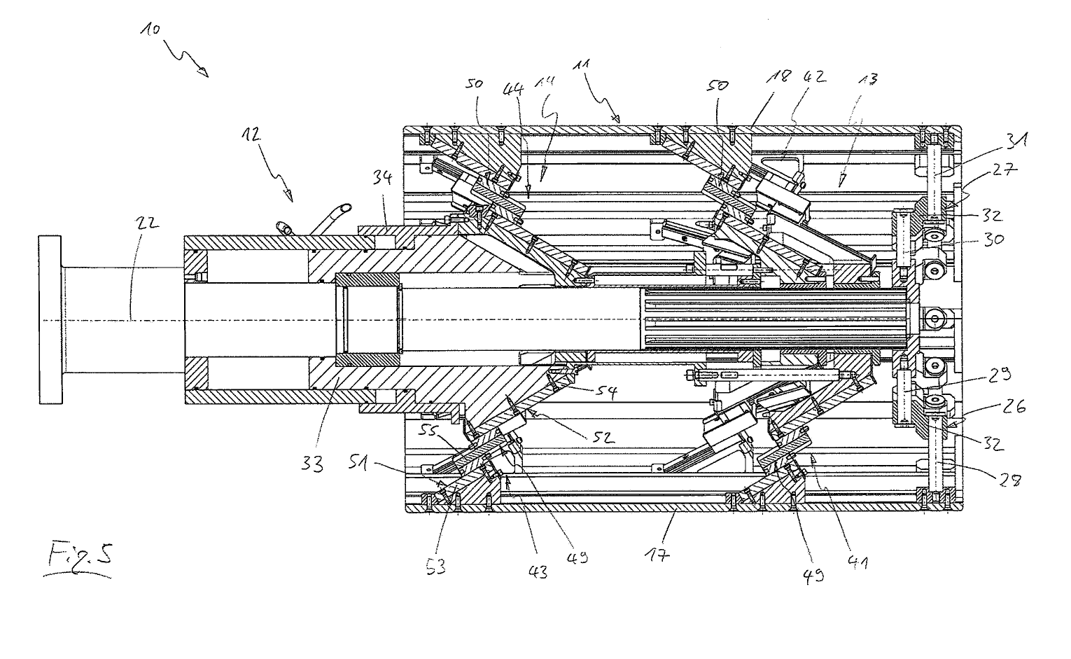

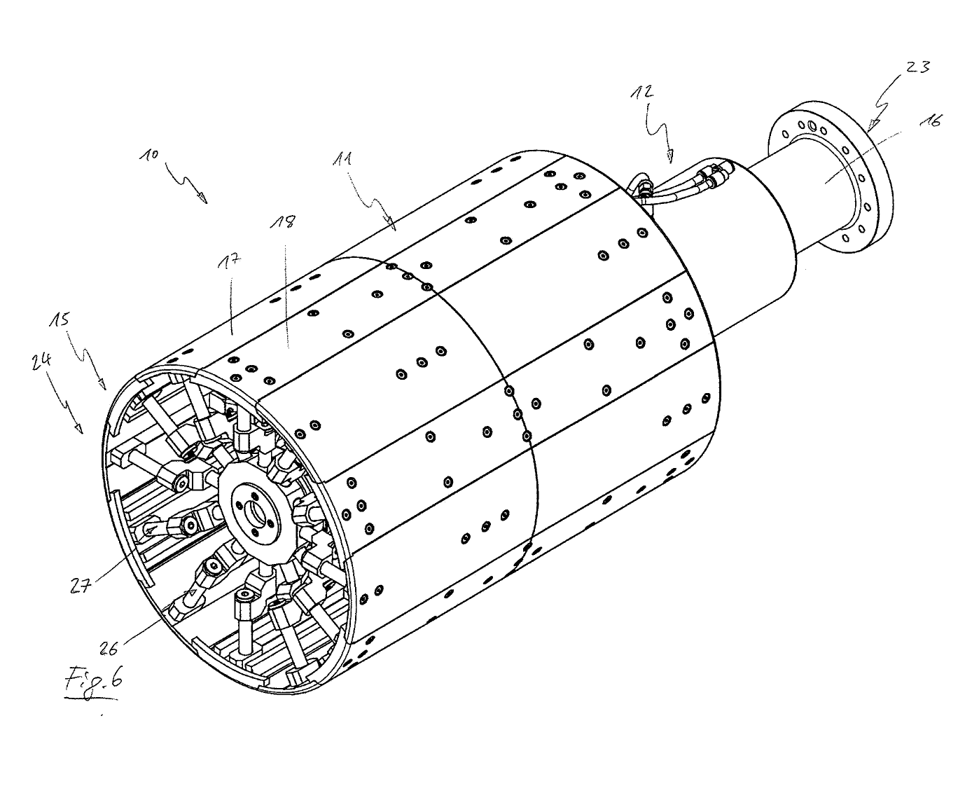

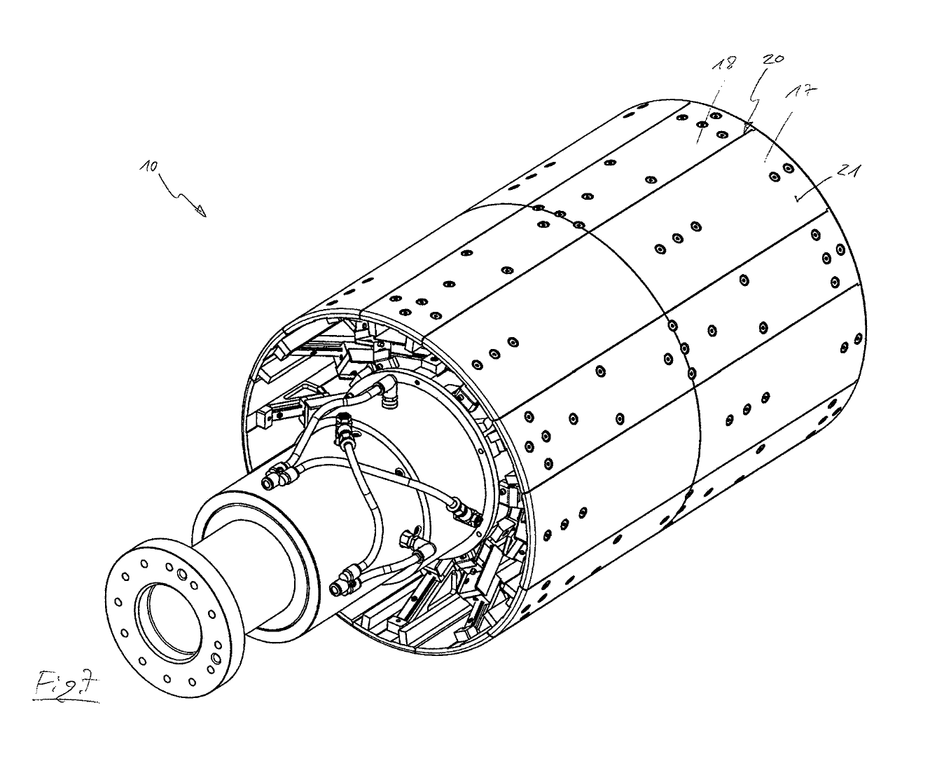

Viewing together FIGS. 1, 3 and 5 to 7 shows a drum 10 for clamping a tire body in an expanded position and FIGS. 2 and 4 show the drum 10 in a contracted position, in which the tire body, which is not illustrated here, can be removed from the drum 10. The drum 10 is formed substantially from a circular cylindrical drum unit 11, an actuation device 12 and deflection devices 13 and 14, and a holding device 15 on a drive shaft 16. The drum unit 11 is formed from circular-arc-shaped, outer drum segments 17 and inner drum segments 18, which are respectively arranged distributed alternately over a periphery 19 of the drum unit 11. The drum segments 17 and 18 are constructed here in a coinciding manner so that in connecting regions 20 of the drum segments 17 and 18, the latter overlap one another and a formation of gaps is avoided. In particular here the outer drum segments 17 project over the inner drum segments 18 on an outer side 21 of the drum unit 11. As can be seen from FIGS. 2 and 4, in a contracted position of the drum unit 11, the inner drum segments 18 can be moved so far in the direction of the drive shaft 16 or respectively of a rotation axis 22 of the drum 10, that these are projected over by the outer drum segments 17 and are largely overlapped.

The drive shaft 16 of the drum 10 has a flange end 23 for connection with a rotation drive, which is not illustrated here in further detail. In addition, a splined shaft section 25 is formed at an opposite end 24 of the drive shaft 16. The splined shaft section 25 enables an axial displaceability of the deflection device 13 and an anti-twist protection thereof on the drive shaft 16, whereby a transmission of a torque can take place from the drive shaft 16 to the drum unit 11.

The holding device 15 is formed from telescopic guides 26 and 27 for respectively outer drum segments 17 or respectively inner drum segments 18. The telescopic guides 26 and 27 connect respectively the outer drum segments 17 or respectively the inner drum segments 18 with the end 24 of the drive shaft 16, so that the drum segments 17 and 18 are held in an axial direction and are movable in a radial direction relative to the rotation axis 22. The telescopic guides 26 and 27 are respectively formed from round bars 28 and 29 or respectively 30 and 31, which in turn are connected with one another via a guide element 32. Thereby, the round bars 28 and 29 or respectively 30 and 31 can be pushed into one another or respectively into the guide element 32, so that the telescopic guides 26 or respectively 27 can be lengthened or shortened.

The actuation device 12 comprises two pneumatic pistons 33 and 34, wherein the pneumatic piston 33 is arranged and guided concentrically on the drive shaft 16. A cylinder chamber 35 of the pneumatic piston 33 is likewise mounted on the drive shaft 16. The pneumatic piston 34 is arranged coaxially on the pneumatic piston 33, wherein a cylinder chamber 36 is formed by the pneumatic piston 34 itself. A movement of the pneumatic piston 33 therefore brings about at the same time a movement of the pneumatic piston 34, wherein the latter can be moved, moreover, relative to the pneumatic piston 33. The actuation device 12 comprises in addition an extension arrangement 37, which is formed from coaxially arranged sleeves 38 and 39. In addition, extension rods 40 are arranged on the sleeve 38. The sleeve 38 is connected securely with the pneumatic piston 33 and the sleeve 39 with the pneumatic piston 34.

The deflection devices 13 and 14 comprise respectively obliquely arranged guide arrangements 41 and 42 or respectively 43 and 44 and a first conical ring 45 and a second conical ring 46 or respectively a first conical ring 47 and a second conical ring 48. In the case of the deflection device 14, the first conical ring 47 is formed from the pneumatic piston 33 and the second conical ring 48 from the pneumatic piston 34. In addition, the first conical ring 45 of the deflection device 13 is securely connected with the sleeve 38 and the second conical ring 46 is securely connected with the extension rods 40 or respectively with the sleeve 39. Consequently, a movement of the pneumatic piston 33 brings about a movement of the first conical rings 45 and 47 and a movement of the pneumatic piston 34 brings about a simultaneous movement of the second conical rings 46 and 48, wherein the two conical rings 46 and 48 are likewise also moved by the movement of the pneumatic piston 33.

The guide arrangements 41 and 43 are respectively arranged in a star-shaped manner on the first conical rings 45 or respectively 47, and the guide arrangements 42 and 44 on the second conical rings 46 or respectively 48. The guide arrangements 41 and 43 are constructed as telescopic guide 49 and the guide arrangements 42 and 44 as telescopic guide 50. As can be seen in the example of the telescopic guide 49, the latter comprises two linear guides 51 and 52, which are formed from guide tracks 53 and 54 and from a guide slide 55. The guide track 53 is fastened to the outer drum segment 17 and the linear guide 52 is fastened to the first conical ring 45 or respectively 47. A movement of the first conical rings 45 and 47 brings about accordingly a movement of the telescopic guide 49 and a movement of the second conical rings 46 and 48 brings about a movement of the telescopic guide 50 respectively such that the inner drum segments 18 or respectively the outer drum segments 17 are moved in radial direction, due to the axial fixing of the holding device 15. In the present example embodiment of the drum 10, the conical rings 45 to 48 have respectively an angle of inclination α relative to the rotation axis 22, wherein according to the size of the angle of inclination α, a transmission takes place of a movement of the pneumatic pistons 33 and 34 in axial direction into a movement of the drum segments 17 or respectively 18 into a radial direction. In addition, in the present example, the first conical rings 45 and 47 are moved over a shorter distance, due to the arrangement of the pneumatic pistons 33 and 34, than the second conical rings 46 and 48. This also produces for the radial movement of the outer drum segments 17 a shorter distance than for the inner drum segments 18, so that the inner drum segments 18, as can be seen in FIG. 2, in the contracted position of the drum unit 11 are arranged within the external diameter d formed by the outer drum segments 17.

1. A drum for the manufacture of a tire, in particular for winding or clamping a tire body, wherein the drum comprises:
a circular cylindrical drum unit formed from circular-arc-shaped drum segments, wherein the drum segments are movable in a radial direction, transversely to a rotation axis of the drum, such that an external diameter of the drum unit is changeable,
an actuation device moving the drum segments in the radial direction; and
a first deflection device having obliquely arranged telescopic guides, wherein the telescopic guides transfer axial movement of the actuation device into radial movement of the drum segments.

2. The drum according to claim 1, in which the drum includes a holding device holding the drum segments in an axial direction.

3. The drum according to claim 2, in which the holding device includes radially arranged guide arrangements, which respectively guide the drum segments in the radial direction.

4. The drum according to claim 3, in which the guide arrangements of the holding device telescopic guides.

5. The drum according to claim 1, in which the telescopic guides are formed from at least two linear guides.

6. The drum according to claim 1, in which the deflection device is connected in a torque-proof manner with a drive shaft of the drum.

7. The drum according to claim 1, in which the drum includes a second deflection device spaced apart from the first deflection device.

8. The drum according to claim 1, in which the drum unit includes a set of outer drum segments and a set of inner drum segments, wherein said inner drum segments and said outer drum segments are respectively arranged alternatively over a periphery of the drum unit.

9. The drum according to claim 8, in which an external diameter D of the drum unit in an expanded position of the drum unit is formed by all drum segments and an external diameter d of the drum unit in a contracted position of the drum unit is formed by solely the outer drum segments.

10. The drum according to claim 8, in which telescopic guides for the inner drum segments have a greater guide length than telescopic guides for the outer drum segments.

11. The drum according to claim 8, in which the deflection device has a first conical ring and a second conical ring, wherein the first conical ring holds telescopic guides for the outer drum segments and the second conical ring holds telescopic guides for the inner drum segments.

12. The drum according to claim 11, in which the conical rings are arranged concentrically on a drive shaft of the drum and are axially movable.

13. The drum according to claim 11, in which the actuation device has at least one fluid piston arranged concentrically on the drive shaft and is axially movable.

14. The drum according to claim 13, in which the actuation device has a second fluid piston.

15. The drum according to claim 14, in which the first conical ring is coupled with the at least one fluid piston and the second conical ring is coupled with the second fluid piston.

16. The drum according to claim 13, in which one of the conical rings is coupled to the at least one fluid piston by means of an extension arrangement of the actuation device.

17. The drum according to claim 13, in which one of the conical rings is formed by the at least one fluid piston.

18. The drum according to claim 13, in which the actuation device includes a control arrangement controlling movement of the at least one fluid piston.
